(19) United States
(12) Patent Application Publication
(10) Pub. No.: US 2013/0127143 A1
(43) Pub. Date: May 23, 2013

(54) PROTECTIVE APPLIANCE FOR VEHICLES

(71) Applicants: Zeev Erlich, Matan (IL); Amir Ohad, Shoham (IL)

(72) Inventors: Zeev Erlich, Matan (IL); Amir Ohad, Shoham (IL)

(21) Appl. No.: 13/516,592

(22) PCT Filed: Dec. 16, 2010
(86) PCT No.: PCT/IB10/55854

§ 371 Date: Jun. 15, 2012

(30) Foreign Application Priority Data
Dec. 16, 2009 (IL) 202763

(51) Int. Cl. B60R 25/00

(52) U.S. Cl. CPC B60R 25/00
USPC 280/762

(57) ABSTRACT

The invention relates to a safety device for blocking access to the voluminous gap (VG) below a vehicle. An object, physically prevents access to the VG is deployed by a deploying mechanism, which is otherwise stored or kept in a stand by position. The object may be camouflaged or conspicuous, while the entire VG may be monitored by a sensor to detect intrusions

### FIELD OF THE INVENTION

The present invention relates to appliances used for the protection of vehicles and their occupants.

### BACKGROUND OF THE INVENTION

Vehicles, such as automobiles, cars, lorries, trucks, limousines, taxis, often attract the attention of villains and law breakers and are vulnerable to both theft and vandalism. Moreover, as cars tend to be identified as a vulnerable property associated with a specific person, cars can be targeted in a personal context, such as for causing personal distress or damage. In some cases, explosive materials have been affixed to vehicles by attaching to the underside, for the purpose of causing physical harm to the occupants of such vehicle. The aim of the present invention is to curb such vulnerability of vehicles.

### SUMMARY OF THE INVENTION

The present invention relates to a protective device for a vehicle in the form of a physical barrier adapted to prevent physical access to the gap or void existing between the bottom of a vehicle, inclusive of the space between the wheels and the body of the vehicle, and the road on which it stands parked. Typically, the device of the invention is stored in a stand-by position such that it is deployable, fulfilling its duty when the vehicle is parked.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective front view of a typical car pointing out the void space between the bottom of the car and road below; and

FIG. 2 is a perspective front view of a typical car in which safety appliance or device in accordance with the invention is employed.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

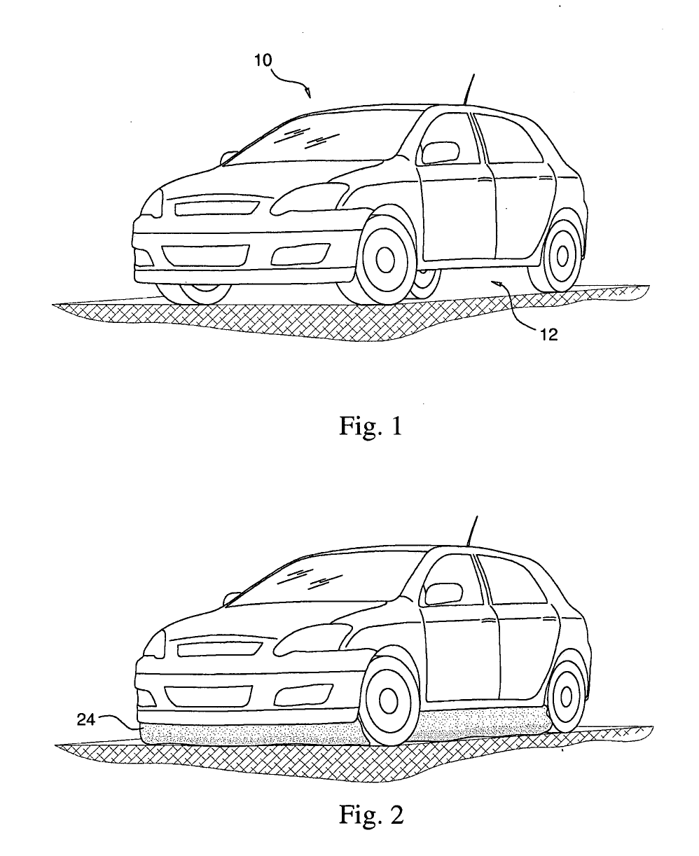

Referring first to FIG. 1, there is shown a typical vehicle, in this case a car, to the protection of which embodiments of the present invention relate. Car 10 stands when parked typically on four wheels that facilitate the formation of a voluminous gap (VG) 12 between the vehicle and the road or earth on which the vehicle is parked. This gap 12 includes also the space between the wheels and the vehicle's body. Unlawful activity, often aimed at the owner or expected driver or other occupant of the car, can be associated with planting of objects below the vehicle. Well known are cases in which a bomb was inserted at the bottom of the vehicle, such as by gluing, magnetically attracting or by some mechanical fixation means.

In one embodiment of the invention, as shown in FIG. 2, the device includes a single or a plurality of inflatable air bags 24 installed at the bottom of car 10, such that when the bags are inflated (as can be seen in the figure), an access blocking effect is provided that prevents or substantially diminishes access to the VG beneath the car. The overall shape of one or more such airbags is round, rectangular, flat, narrow, wide or any other applicable shape. The color of air bag 24 may be variegated or uniform, vivid or dull, camouflage-colored, asphalt gray, soil brown, green, conspicuous or inconspicuous.

In some embodiments of the invention, screens made of strong fabric (woven or non-woven) are installed beneath the lower rim of the vehicles, so that they can be pulled down or stretched towards the road surface, or earth, or whichever surface the car is parked on. Other materials can be used instead of fabric, for example plastic sheets, metal sheets, meshes, nets, or slatted screens.

In the systematic fitting of the device of the present invention, especially from the commercial point of view, can be either appended to regular vehicles, or the vehicles may be a priori manufactured with a housing in which the device is kept in a stand-by position.

To deploy the device some action is required, at least for releasing the device from its stored or stand-by position. This action can be initiated by manually releasing a securing object such as a latch, enabling the device to be released from its stored or stand-by position, or automatically by the person wishing to deploy the device actuating an electric signal that initiates one or more mechanical actuators that deploy the device.

### Shape and Structure of a Device of the Invention

The device of the invention may be fabricated in any manner which would lend it capable of deploying from a stored or stand-by position and when deployed, providing the access blocking effect to the VG in the sub vehicular space. In some embodiments, the device includes an access blocking object that is tough and inflexible, such as laths or plates or strips of metal, wood or plastic material. Such access-blocking objects can be hinged or pivoted, deployed by swiveling into a more or less erected state, and folded back when stored. Such folding/unfolding can be effected by hand or by mechanical or hydraulic or electrical actuators. In some embodiments, a set of shutters/blinds peripherally covers the VG when deployed. In some embodiments, a metal mesh curtain is rollable downwards and upwards.

### Intrusion Detection

In some embodiments, the device includes an intrusion detection system including one or a plurality of sensors positioned in the VG of the sub vehicular space or around the vehicle to detect intrusion. Sensor/s typically point toward the inside of the VG so that an intruding object may be detected. To effectively transmit the information, possibly in real time, the sensor/s are connected to a transmitter, such as a cellular phone, and upon detection of an intrusion, a communication is sent to a guardian or to the driver. Sensor/s may be any passive infrared detector, optical detector or mechanical motion detector. The intrusion detection system can be adapted to provide an alarm in the event of an intrusion.

### Animal Deterrence

Animals entering the sub vehicular space may cause a false alarm in the sense that the animal entering had no intention of causing harm, unless it is used by a human to carry a malicious load. In order to preclude animals from entering the sub-vehicular space, physical hurdles or implements may be deployed as a part of the access blocking gear as described above. As an example, transparent wires (plastic or other) can be employed and have a density that will preclude regular four legged creatures from entering the VG. The transparency may be an advantage if disguise of the implement is required. In some embodiments, the wires may be electrified to increase the deterrence.

### Types of Vehicles in Which the Invention is Applicable

The invention is implementable in wheeled vehicles, employing any number of wheels, such as having four, six or more wheels, singly or doubly pivoted.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Although the instant invention has been described in relation to particular embodiments thereof, many other variations and modifications and other uses will become apparent to those skilled in the art.

1. A safety device for providing an access blocking effect to the voluminous gap (VG) below a vehicle, said device comprising:
at least one deployable object, adapted to be releasable from a stored or stand-by position;
a deploying mechanism from said stored or stand by position, wherein said at least one deployable object is adapted to physically prevent access to said VG.

2. A safety device as in claim 1 wherein said VG is inclusive of the volume between the wheels and the body of said vehicle.

3. A safety device as in claim 1 wherein said safety device is stored in a housing.

4. A safety device as in claim 1, further including an intrusion detection system comprising at least one sensor for the detection of intrusions into said VG.

5. A safety device as in claim 4 wherein said intrusion detection system further comprising a transmitting device connected to the at least one sensor.

6. A safety device as in claim 1 wherein said deploying mechanism is powered by any agent selected from the group including mechanical, hydraulic, manual, and electric power.

7. A safety device as in claim 1 wherein said deployable object is made from at least one of the materials selected from the group including: wood, plastic polymer, and metal.

8. A safety device as in claim 1 wherein said deployable object is made in the form of at least one inflatable bag.

9. A safety device as in claim 1 wherein said deployable object is made in the form of at a net.

10. A safety device as in claim 1 wherein said deployable object is made in the form of laths.

11. A safety device as in claim 1 wherein said deployable object is made of tough, non flexible material deployable downwards in direction.

12. A safety device as in claim 8 wherein said at least one bag is colored.

13. A safety device as in claim 8 wherein said at least one bag is shaped.

14. A safety device as in claim 1 further comprising at least one physical hurdle adapted to deter animals.
